(19) United States
(12) Patent Application Publication
(10) Pub. No.: US 2021/0400926 A1
(43) Pub. Date: Dec. 30, 2021

(54) BEEHIVE PROTECTION DEVICE AND DATA COLLECTION APPARATUS

(71) Applicant: DeftIO LLC, San Francisco, CA (US)

(72) Inventor: Manjirnath Chatterjee, Alameda, CA (US)

(21) Appl. No.: 17/341,381

(22) Filed: Jun. 7, 2021

Related U.S. Application Data
(63) Continuation of application No. 63/035,557, filed on Jun. 5, 2020.

(51) Int. Cl. A01K 51/00; A01K 57/00

(52) U.S. Cl. CPC A01K 51/00; A01K 57/00

(57) ABSTRACT

A protective system is provided for insect living enclosures such as beehives. The protective system includes a listening subsystem and a spray subsystem. The spray subsystem is positionable to enable an agent to be dispensed from an outlet in a desired location relative to an entrance of the insect living enclosure. The listening subsystem is further operable to acoustically detect a threat about the entrance. Further, in response to detecting the threat, the listening subsystem is operable to control the spray subsystem to dispense the agent from the outlet.

### RELATED APPLICATIONS

This application claims benefit or priority to provisional U.S. Application No. 63/035,557, filed on Jun. 7, 2020, the aforementioned priority application being hereby incorporated by reference in entirety.

### BACKGROUND

FIG. 3A and FIG. 3B illustrate prior art beehives. As shown, a beehive 300 includes an entrance 410 where there is a traffic of bees 302. Worker bees create honeycombs in frames inside for honey extraction (not shown). Workers can enter/leave the hive through the entrance 310. Hornet attacks which occur typically occur through the entrance to the hive. For example, as shown by FIG. 3B, when a hornet scout attacks, it goes through the entrance. When a hornet scout approaches the beehive, it is typically much larger than a honeybee. If it decides to enter the nest then western honeybees may not have defenses whereas Apis cerana japonica may form a defensive “beeball”. If the hornet scout leaves and returns with its hive mates it can devastate the hive killing thousands of bees in just an hour.

### BRIEF DESCRIPTION OF FIGURES

FIG. 1A and FIG. 1B illustrate a beehive or insect living enclosure, according to one or more embodiments.

FIG. 2 illustrates a beehive or other insect living enclosure, under another embodiment.

FIG. 3A and FIG. 3B illustrate prior art beehives.

### DETAILED DESCRIPTION

Embodiments include a protective system is provided for insect living enclosures such as beehives. In examples, a protective system includes a listening subsystem and a spray subsystem. The spray subsystem is positionable to enable an agent to be dispensed from an outlet in a desired location relative to an entrance of the insect living enclosure. The listening subsystem is further operable to acoustically detect a threat about the entrance. Further, in response to detecting the threat, the listening subsystem is operable to control the spray subsystem to dispense the agent from the outlet.

In some embodiments, the listening subsystem includes an acoustic sensor and a signal processor. The signal processor is coupled to the acoustic sensor to detect an acoustic signal for activity that occurs about an entrance of the enclosure. Still further, the acoustic sensor can be positioned at or near the entrance of the insect enclosure.

Still further, in some examples, the listening subsystem acoustically detects a threat to the insect enclosure by comparing the acoustic signal of the activity about the entrance with an acoustic threat signature. In some examples, the threat signature is the sound of a wasp or other specifies of Hymenoptera insect, where the insect living enclosure is a beehive. In some variations, the listening subsystem acoustically detects the threat by comparing the acoustic signal of the activity about the entrance with acoustic signals logged from prior time intervals. Thus, for example, the listening subsystem can detect a threat when the acoustic signal of the activity about the entrance is abnormal as compared to acoustic signals logged from prior time intervals.

In some examples, the spray subsystem includes a reservoir, a control valve and a spray head. The reservoir retains the agent above the entrance so that gravity at least partially forces the agent to dispense when the control valve is in an open state. Further, the control valve can be controllable by the listening subsystem between open and closed states. Still further, in some examples, the spray head and the acoustic sensor are positioned within a threshold distance of one another.

In variations, the protective system can be powered in whole or in part by a solar power subsystem and/or battery module.

In other embodiments, an assembly is provided for use as an insect living enclosure (e.g., beehive). The assembly can include an insect living structure (e.g., beehive structure to house bees) having an entrance. Further, the assembly can include a protective system such as shown and described by various examples, The listening subsystem is operable to acoustically detect a threat about the entrance, and in response to detecting the threat, control the spray subsystem to dispense the agent from the outlet.

With respect to examples as described, the agent can be any liquid, powder, gas (including aerosol) that is harmful to a particular type of insect. For example, the agent can be dish soap, which is known to be harmful to wasps.

In examples, the assembly can be configured to allow for the protective subsystem to be assembled about the insect living enclosure.

Still further, in some examples, a method is provided to acoustically monitor an entrance of an insect living enclosure. Through acoustic monitoring, a threat is detecting to the insect living enclosure. In response to detecting the threat, a spray subsystem is controlled to dispense an agent about the entrance of the insect living enclosure.

A method such as described by some examples can be implemented using a protective system such as described with various examples and embodiments.

According to examples, a device, system, assembly and method is provided for protecting commercial beehives from aggressive insect species. It works by sensing the presence of aggressive insects approaching the hive entrance via sensors and then activates a protective spray which hits the invaders or scouts. The sprayed invaders or scouts and incapacitated and no longer can attack the hive or return to their home hives to bring back extra works to launch a larger attack thereby protecting the hive.

Some embodiments relate to the protection of beehives which may be vulnerable to attack from predatory flying insects. For example commercial honey bees such as Apis Mellifera, do not have a defense against an attack from Vespa Mandarinia, a large giant wasp family. In this case the wasps send a scout which, if it finds a hive, will bring back dozens of wasps to attack said hive. These aggressive wasps can kill as many as 30 bees per minute each by using their large mandibles and are immune for stings from regular bees. A swarm of these wasps can kill tens of thousands of bees in an hour devastating the hive. The wasps then invade the hive and take home the bee larvae to feed to their own brood.

Bees in certain regions of the world are adapted to these attacks. When a scout approaches they form a massive “bee ball” around the invading scout. By beating their wings aggressively these bees then are able to raise the temperature around the invader to such a point as to kill it via heat. This process can consume over a hundred bees but since the invading scout does not return to its own nest the hive is saved from a larger attack.

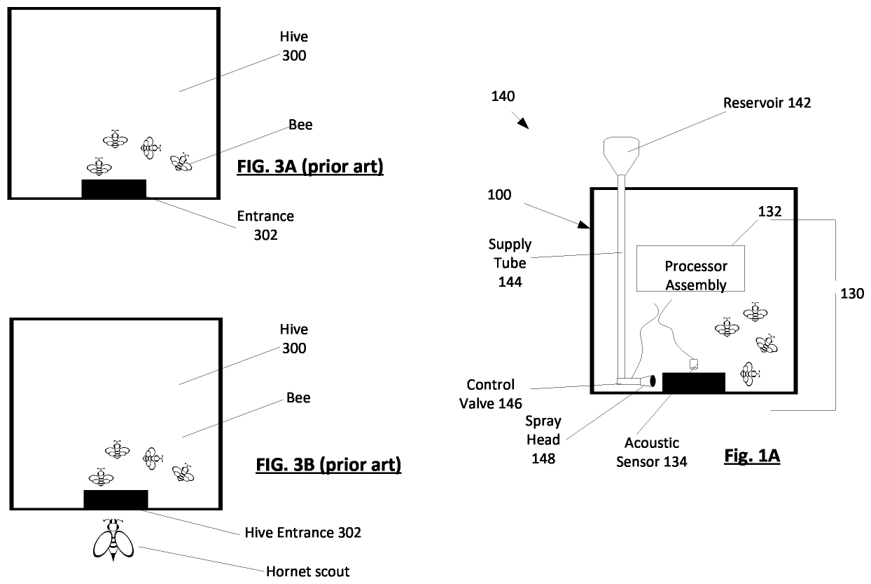

FIG. 1A and FIG. 1B illustrates a beehive with a protective subsystem to guard against insect intruders such as hornets. As shown in FIG. 1A, a beehive structure 110 houses bees of a colony. A protective system 120 is coupled with the beehive structure 110 to protect the colony of bees. In examples, the protective system 120 includes a listening subsystem 130 and a spray subsystem 140.

The listening subsystem 130 includes a signal processor(s) 132 and an acoustic sensor 134 (e.g., microphone). The acoustic sensor 134 can be positioned about an entrance 102 of the beehive structure 110. In this way, the acoustic sensor 134 can capture sounds from a region of the entrance 102. In some examples, the acoustic sensor 134 is positioned relative to the entrance 102 to capture sounds of activity that are in front of but exterior to the beehive structure 110. In variations, the acoustic sensor 134 is positioned to capture sounds which are at the threshold of the entrance, or just inside the interior of the beehive structure 110. Still further, in some variations, the beehive structure 110 includes multiple entrances 102, and each entrance includes or is provided with a corresponding acoustic sensor 134.

The signal processor 132 includes circuitry, electronics, firmware, software or other logic to (i) store baseline acoustic information, (ii) capture and process sounds generated from activity about the entrance 102, and (iii) compare an acoustic signal of the captured/processed sounds with the baseline acoustic information to determine when there is a threat to the colony of bees. In examples, the signal processor 132 implements an adaptive acoustic signature detector that is tuned, or otherwise configured to detect a particular type of threat. For example, for a colony of beehives, the threat may correspond to a wasp or hornet, such as a scout hornet.

According to variations, the signal processor 132 of the listening subsystem 132 can use machine learning or artificial intelligence pattern matching techniques to most accurately and efficiently identify bee activity and predator visits. This is far superior than using frequency based bands as has been done in the past since it is more accurate and can be used to identify predator types even in the presence of intense bee activity or masking such as during storms or human visits to the hive.

Still further, in some examples, the baseline acoustic information corresponds to an acoustic threat signature, where the acoustic threat signature is the sound of, for example, a hornet scout. As an addition or variation, the acoustic information corresponds to sounds of bee traffic through the entrance 102 during prior time intervals (e.g., sounds of bees over several days). For example, the normal sounds of the colony can be recorded and logged over several days or other time interval. The signal processor 132 can then detect when there is a significant deviation as between a current beehive activity at the entrance 102 and the “normal” sound of the beehive.

In examples, the 140 includes a reservoir 142, a supply tube 144, a control valve 146 and a spray head 148. The reservoir 142 stores an agent that can kill or otherwise deter an invading organism (e.g., hornet). For example, the reservoir 142 can be used to store a dish soap solution. The control valve 146 can be coupled to the signal processor 132. The signal processor 132 operates to acoustically monitor and detect a threat to the colony of the 110. The reservoir can be used to retain a soapy liquid, pesticide or other agent to kill, for example, hornets or wasps.

As shown by FIG. 1B, when a threat is detected, the signal processor 132 signals the valve 146 to open (e.g., from a default closed position). An agent (e.g., dish soap solution, toxin) is then dispensed via the spray head 148. In examples, the agent is dispensed with the reservoir 142 and the supply tube 144 being arranged above the entrance 102 so that the agent is gravity fed through the entrance 102. In variations, a pressurized cannister, motor spray assembly or other mechanism is used to dispense the agent once the valve 146 is opened. Still further, the spray head 148 can be provided or equipped with a targeted servo-mechanism. As a variation to using spray (e.g., projected liquid or aerosal), the spray subsystem140 can utilize a projective, energy beam or projection (e.g., laser, microwave, steered RF, or pressurized tubing).

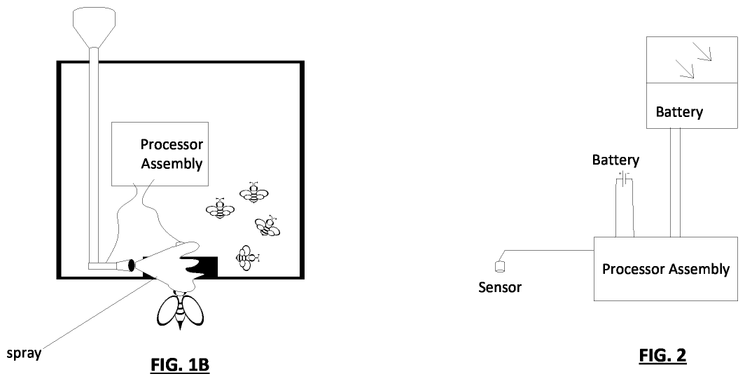

FIG. 2 illustrates another example of a protection assembly for a beehive (or other insect living enclosure). With reference to FIG. 2, the protection assembly 200 includes a solar subsystem 210 and/or battery module 220 that can at least partially power one or more components of the protection assembly 200. In variations, the assembly 200 can be operated through a mains connection or alternative renewable resource (e.g., wind-turbine, etc.). The assembly 200 further includes a listening subsystem 230 having a signal processor 232 and one or more acoustic sensors 234 that are operative coupled to the signal processor 232.

In variations, the listening subsystem 132, 230 includes a signal processor that daps across network units, utilizes sleep cycles to save power, and operates separately in a listening (e.g., passive) or active mode. In examples, the 232 can be adaptive and operative through a network connection and interface (Network interface (IOT/WiFi, Cellular, Zigbee, WAN, BT, mesh, NFC).

Among other advantages, examples as described can utilize adaptive signal processing to distinguish normal bee activity from predators.

It can protect a beehive in all normal weather conditions, including at night or wet weather, with simple refillable spray action

It can log and detect both normal bee activity, predator visits, and other events, so that wildlife officials and beekeepers can coordinate monitor activities.

It can operate indefinitely on renewable power as sentinel thereby allowing long term inexpensive operation

It can be coordinated with multiple sites to map both normal bee and predator activities

The spray can be a soapy water which is non-toxic to humans but highly toxic to hornets. This will prevent the hornet from returning to its nest to bring other scouts.

It also leaves the hornet nest intact—allowing the hornets to predate other insect pests while not interfering with honey bees.

Minimal numbers of bees would be impacted allowing honey operation to be uninterrupted.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A protective system for beehives, the protective system comprising:
a listening subsystem;
a spray subsystem including an outlet, the spray subsystem being positionable to enable an agent to be dispensed from the outlet in a desired location relative to an entrance of a beehive;
wherein the listening subsystem is operable to:
acoustically detect a threat about the entrance; and
in response to detecting the threat, control the spray subsystem to dispense the agent from the outlet.

2. The protective system of claim 1, wherein the listening subsystem includes an acoustic sensor and a signal processor, the signal processor being coupled to the acoustic sensor to detect an acoustic signal for activity about the entrance.

3. The protective system of claim 2, wherein the listening subsystem is structured to position the acoustic sensor at or near the entrance of the beehive.

4. The protective system of claim 2, wherein the listening subsystem acoustically detects the threat by comparing the acoustic signal of the activity about the entrance with an acoustic threat signature.

5. The protective system of claim 4, wherein the acoustic threat signature is based on an emitted sound of a wasp or species of Hymenoptera insect.

6. The protective system of claim 2, wherein the listening subsystem acoustically detects the threat by comparing the acoustic signal of the activity about the entrance with acoustic signals logged from prior time intervals.

7. The protective system of claim 6, wherein the listening subsystem acoustically detects the threat by determining that the acoustic signal of the activity about the entrance is abnormal as compared to acoustic signals logged from prior time intervals.

8. The protective system of claim 1, wherein the spray subsystem includes a reservoir, a control valve and a spray head, wherein the reservoir retains the agent above the entrance so that gravity at least partially forces the agent to dispense when the control valve is in an open state.

9. The protective subsystem of claim 8, wherein the control valve is controllable by the listening subsystem.

10. The protective subsystem of claim 9, wherein the spray head and the acoustic sensor are positioned within a threshold distance of one another.

11. The protective subsystem of claim 1, further comprising:
a solar power subsystem to at least partially power at least one of the listening subsystem or the spray subsystem.

12. The protective subsystem of claim 1, further comprising:
a battery module to at least partially power at least one of the listening subsystem or the spray subsystem.

13. A beehive assembly comprising:
a beehive structure to house bees, the structure including an entrance; and
a protective system including a listening subsystem and a spray subsystem, the spray subsystem being positionable to enable an agent to be dispensed from the outlet in a desired location relative to the entrance;
wherein the listening subsystem is operable to:
acoustically detect a threat about the entrance; and
in response to detecting the threat, control the spray subsystem to dispense the agent from the outlet.

14. The beehive assembly of claim 13, wherein the protective system is structured to be assembled to the beehive structure.

15. The beehive assembly of claim 14, wherein the beehive structure includes an entrance that is positioned at a base of the beehive structure, the spray subsystem includes a reservoir that is positioned above the entrance, with an outlet provided near or adjacent to the entrance, such that the agent is retainable in the reservoir and gravity-fed to the entrance under control of the listening subsystem.

16. A method for protecting a beehive, the method comprising:
acoustically monitoring an entrance of the beehive;
detecting, from acoustically monitoring, a threat to the beehive; and
in response to detecting the threat, controlling a spray subsystem to dispense an agent about the entrance of the beehive.

17. The method of claim 16, wherein detecting the threat includes comparing an acoustic signal of an activity about the entrance with an acoustic threat signature.

18. The method of claim 17, wherein the acoustic threat signature is based on an emitted sound of a wasp or species of Hymenoptera insect.

19. The method of claim 16, wherein detecting the threat includes comparing the acoustic signal of the activity about the entrance with acoustic signals logged from prior time intervals.

20. The method of claim 19, wherein detecting the threat includes determining that the acoustic signal of the activity about the entrance is abnormal as compared to acoustic signals logged from prior time intervals.
